(19) United States
(12) Patent Application Publication
(10) Pub. No.: US 2013/0000072 A1
(43) Pub. Date: Jan. 3, 2013

(54) CLAMPING ASSEMBLY

(75) Inventors: Gareth Leuan Jones, Raleigh, NC (US); Sage Frederick Smith, Apex, NC (US); John William Salay, Pittsboro, NC (US)

(73) Assignee: Caterpillar Inc., Peoria, IL (US)

(21) Appl. No.: 13/173,662

(22) Filed: Jun. 30, 2011

(51) Int. Cl. F16L 5/02; F16L 5/00

(52) U.S. Cl. 16/2.2; 16/2.1

(57) ABSTRACT

A clamping assembly for permitting passage of an elongated member through a wall. The clamping assembly includes a first clamping member and a second clamping member. The first clamping member includes a first arm extending outwardly from a first central portion of the first clamping member. The second clamping member includes a second arm extending outwardly from a second central portion of the second clamping member. The second clamping member is configured to be removably engaged with the first clamping member, such that the first arm and the second arm define an opening for permitting passage of the elongated member.

### TECHNICAL FIELD

The present disclosure relates to a clamping assembly, and more particularly to a clamping assembly for permitting passage of an elongated member through a wall.

### BACKGROUND

Elongated members, such as hoses, are often required to be passed through walls, such as a wall of a machine surface. Conventionally, connectors such as, cut-outs with p-clips or stauff clamps and the like are employed. Typically, in order to pass the elongated members through the walls, the elongated members are required to be broken into two parts. A connector is then attached to a hole on the wall and the parts of the elongated members are connected on both sides of the connector.

U.S. Pat. No. 6,957,817 discloses a seal assembly comprising an elastomeric gland having insert openings and fastener openings. Elastomeric inserts are removably disposed in the gland insert openings. The inserts have removable portions to form one or more cable openings. Thus, cable(s) can be placed in the cable openings. End plates are disposed at each end of the gland. The end plates are formed of complementary plate members, which, when mated together, form a unitized end plate defining fastener openings and cable openings.

### SUMMARY

In one aspect, the present disclosure provides a clamping assembly for permitting passage of an elongated member through a wall. The clamping assembly includes a first clamping member and a second clamping member. The first clamping member includes a first arm extending outwardly from a first central portion of the first clamping member. The second clamping member includes a second arm extending outwardly from a second central portion of the second clamping member. The second clamping member is configured to be removably engaged with the first clamping member, such that the first arm and the second arm define an opening for permitting passage of the elongated member through the wall.

In another aspect, the present disclosure also discloses a method of permitting passage of an elongated member through a wall. The method includes receiving the elongated member through an aperture on the wall; engaging a first clamping member to the aperture; engaging a second clamping member to the first clamping member; inserting a tightening member through each of a first hole of the first clamping member and a second hole of the second clamping member; and, turning the tightening member for locking the second clamping member with respect to the first clamping member.

Other features and aspects of this disclosure will be apparent from the following description and the accompanying drawings.

### BRIEF DESCRIPTION OF THE DRAWINGS

FIG. 1 is a perspective diagram of a clamping assembly engaged with a wall, according to an aspect of this disclosure;

FIG. 2 is a front unassembled perspective diagram of the clamping assembly of FIG. 1;

FIG. 3 is a rear unassembled perspective diagram of the clamping assembly of FIG. 1;

FIG. 4 is a perspective diagram of a clamping assembly, according to another aspect of this disclosure; and

FIG. 5 is a flow chart for a method of permitting passage of an elongated member through an aperture.

### DETAILED DESCRIPTION

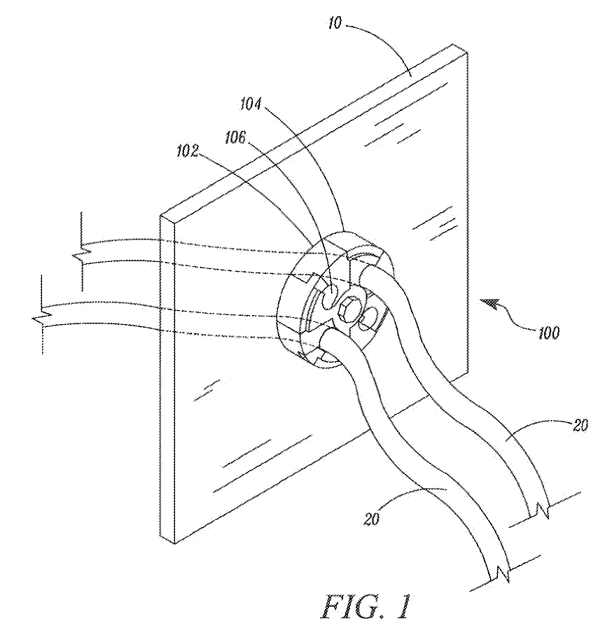

FIG. 1 shows a perspective diagram of a clamping assembly 100, according to an embodiment of the present disclosure. The clamping assembly 100 may be engaged with a wall 10. The wall 10 may be a housing wall associated with an internal combustion engine of a machine, such as a skid steer loader, multi-terrain loader, compact track loader, and the like. Alternatively, the wall 10 may be any wall of an industrial or household vessel. FIG. 1 also shows elongated members 20, passing through the wall 10. The elongated members 20 may include hoses, tubes, harnesses, cables, fluid supply lines and the like, that may be required to be passed through the wall 10.

The clamping assembly 100 includes a first clamping member 102. The first clamping member 102 may be composed of metal, plastic or rubber. The clamping assembly 100 further includes a second clamping member 104. The second clamping member 104 may also be composed of metal, plastic or rubber. In an embodiment of the present disclosure, the second clamping member 104 may be structurally identical to the first clamping member 102. In an alternative embodiment of the present disclosure, the second clamping member 104 and the first clamping member 102 may be structurally different. Further, the second clamping member 104 is configured to be removably engaged with the first clamping member 102. The engagement of the second clamping member 104 with the first clamping member 102 defines one or more openings 106. The openings 106 are configured to permit passage of the elongated members 20. Specifically, each of the openings 106 conform to an external surface of the elongated members 20 thereby permitting passage of the elongated members 20 while sealing the wall 10, at the same time.

In an exemplary embodiment, four openings are defined and therefore four elongated members may be passed therethrough. It may herein be apparent to those skilled in the art that, any number of openings may be defined by the second clamping member 104 and the first clamping member 102, without deviating from the spirit of the present disclosure.

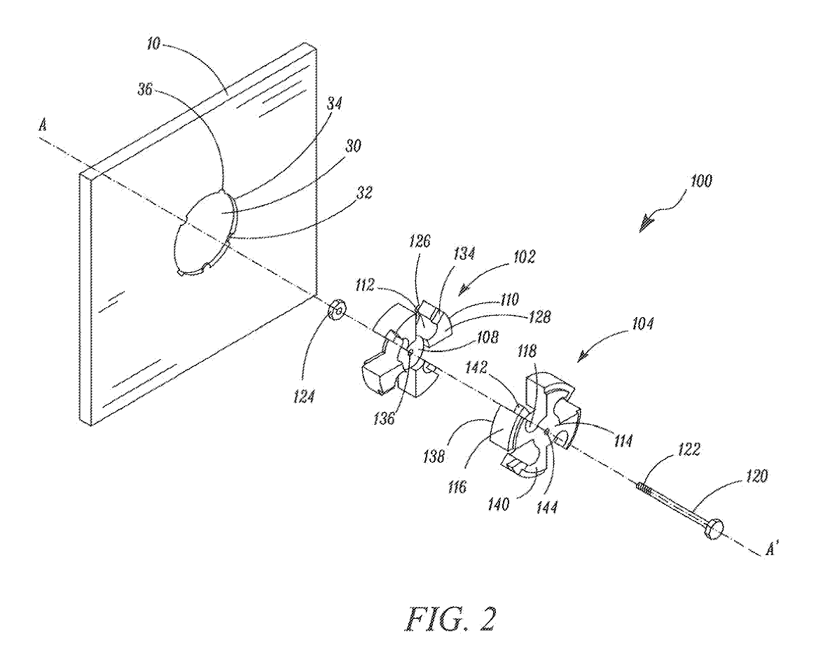

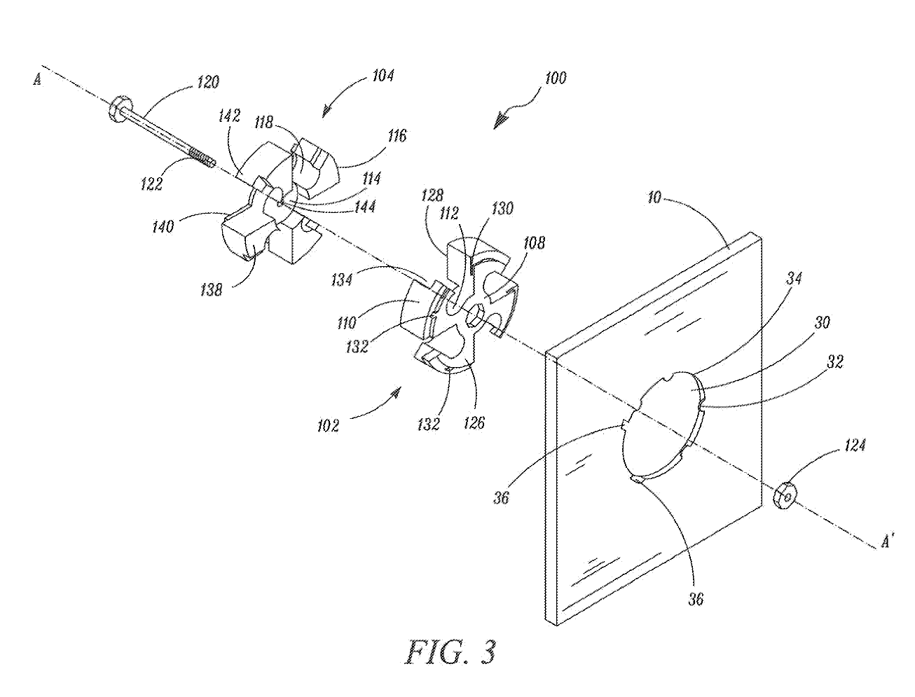

Referring now to FIGS. 2 and 3, which shows a front unassembled perspective diagram and a rear unassembled perspective diagram respectively, of the clamping assembly 100. As shown in FIG. 2 and FIG. 3, the wall 10 may be provided with an aperture 30. The aperture 30 may be a bulkhead hole preexisting on the wall 10. Alternatively, the aperture 30 may be made on the wall 10, using conventional techniques known to those skilled in the art, for example, punching, machining and the like. The aperture 30 is shown to have a circular configuration; however the aperture 30 may alternatively have any other configuration, such as rectangular or square configuration, without departing from the scope of the present disclosure. In an embodiment of the present disclosure, the aperture 30 on the wall 10 includes slide tabs 32 on a peripheral surface 34 of the aperture 30. The aperture 30 on the wall 10 further includes an anti-rotation slot 36 on the peripheral surface 34 of the aperture 30.

The first clamping member 102 may be configured to be engaged with the aperture 30 on the wall 10. Alternatively, the second clamping member 104 may be engaged with the aperture 30 on the wall 10. Specifically, the first clamping member 102 may be engaged with the peripheral surface 34 of the aperture 30. In alternative embodiments of the present disclosure, where the aperture 30 may have a rectangular or square configuration, the first clamping member 102 may engage with peripheral sides of the aperture 30. The first clamping member 102 includes a first central portion 108 and a first arm 110 extending outwardly from the first central portion 108. In an embodiment of the present disclosure, a plurality of arms, such as the first arm 110, may be disposed at an angular relation with respect to one another and may extend radially from the first central portion 108 of the first clamping member 102.

The first arm 110 of the first clamping member 102 includes a grooved portion 112. The grooved portion 112 may be semicircular in configuration. Alternatively, the grooved portion 112 may have any other configuration depending upon a shape of the elongated members 20.

The second clamping member 104 includes a second central portion 114 and a second arm 116 extending outwardly from the second central portion 114. In an embodiment of the present disclosure, a plurality of arms, such as the second arm 116 may be disposed at an angular relation with respect to one another and may extend radially from the second central portion 114 of the second clamping member 104.

The second arm 116 of the second clamping member 104 includes a complimentary grooved portion 118. The complimentary grooved portion 118 may also be semicircular in configuration. In an embodiment of the present disclosure, each of a plurality of second arm 116 may include a complimentary grooved portion 118. The engagement of the second clamping member 104 with the first clamping member 102 positions the grooved portion 112 in alignment with the corresponding complimentary grooved portion 118, such that the openings 106 are defined.

The clamping assembly 100 further includes a tightening member 120 having an elongated configuration. The tightening member 120 is capable of being removably inserted through each of the first clamping member 102 and the second clamping member 104. A free end portion 122 of the tightening member 120 may engage with a nut 124. The tightening member 120 may be rotated for locking and unlocking the second clamping member 104 with respect to the first clamping member 102. Alternatively, the clamping assembly 100 may include two or more tightening members based on the application and size of the first and the second clamping members 102 and 104.

Referring now to FIG. 3, the first clamping member 102 of the clamping assembly 100 includes a mounting portion 126 and a mating portion 128 opposite to the mounting portion 126. The mounting portion 126 of the first clamping member 102 includes slide slots 130. The slide slots 130 on the mounting portion 126 of the first clamping member 102 are configured to slidably receive the slide tabs 32 for engaging the first clamping member 102 to the aperture 30. The mounting portion 126 of the first clamping member 102 further includes locking tab 132. The locking tab 132 is configured to mesh with the anti-rotation slot 36 on the peripheral surface 34 of the aperture 30 of the wall 10. The meshing of the locking tab 132 with the anti-rotation slot 36 may lock the first clamping member 102 against a relative rotation. The first clamping member 102 further includes a cut-out portion 134 at the first arm 110. Moreover, a first though hole 136 may be defined in the first central portion 108 of the first clamping member 102. The first hole 136 of the first clamping member 102 may optionally have a threaded internal surface.

The second clamping member 104 includes a mating portion 138 and a fastening portion 140 opposite to the mating portion 138. The mating portion 138 of the second clamping member 104 engages with the mating portion 128 of the first clamping member 102. The mating portion 138 of the second clamping member 104 includes a projecting portion 142 at the second arm 116. The projecting portion 142 of the second clamping member 104 engages with the cut-out portion 134 of the first clamping member 102, during engagement of the first clamping member 102 with the second clamping member 104. Moreover, a second though hole 144 defined in the second central portion 114 of the second clamping member 104. The second hole 144 of the second clamping member 104 may also optionally have a threaded internal surface. Upon engagement of the first clamping member 102 with the second clamping member 104, the first hole 136 may be in alignment with the second hole 144 along an axis A-A′. The tightening member 120 may be removably inserted through the second hole 144 and the first hole 136 for locking and unlocking the second clamping member 104 with respect to the first clamping member 102.

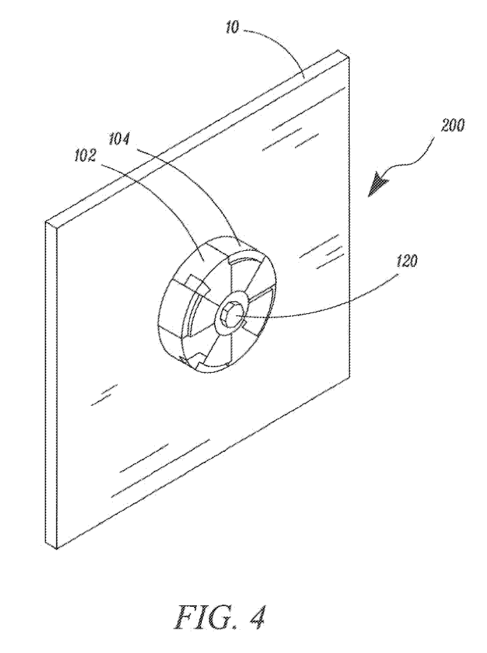

FIG. 4 illustrates a clamping assembly 200, according to another embodiment of the present disclosure. The clamping assembly 200 may function to seal the aperture 30 on the wall 10. In this embodiment of the present disclosure, the clamping assembly 200 may be structurally same as the clamping assembly 100; however the grooved portion and the complimentary grooved portion may be absent. Therefore, the engagement of the first clamping member 102 to the second clamping member 104, in the present embodiment, may seal the aperture 30 on the wall 10.

In yet another embodiment of the present disclosure, the clamping assembly 100 may be provided in the form of a clamping assembly kit. The clamping assembly kit may include the first clamping member 102 and the second clamping member 104. The clamping assembly kit further includes the tightening member 120.

### INDUSTRIAL APPLICABILITY

Typically, elongated members such as hoses, tubes harnesses and the like, are required to be broken into two parts to pass through a wall of a machine surface. The clamping assembly 100 of the present disclosure enables passage of the elongated members through the wall without the need of breaking the elongated members.

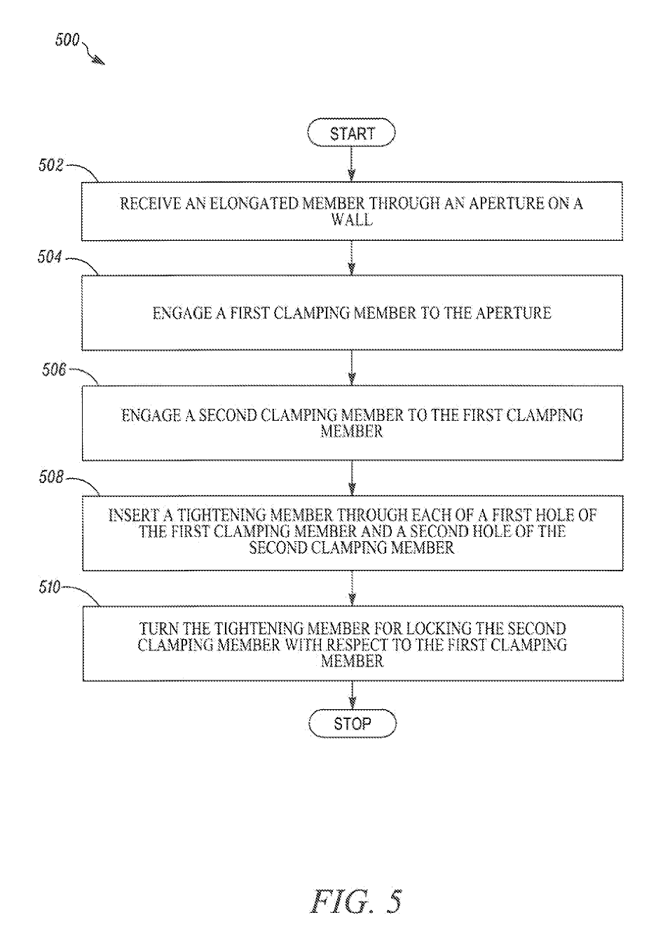

As depicted by flow diagram of FIG. 5, a method 500 of permitting passage of the elongated members 20 through the wall 10, is disclosed herein. At step 502, the elongated members 20 are received through the aperture 30 on the wall 10. At step 504, the first clamping member 102 is engaged to the aperture 30. Specifically, at step 502, the first clamping member 102 is placed at the aperture 30. Thereafter, the first clamping member 102 is rotated to enable slidable receiving of the slide tabs 32 within the slide slots 130. The rotation also causes the locking tab 132, to engage with the anti-rotation slot 36. It may be apparent to those skilled in the art that rotation in an opposite direction of the first clamping member 102 may disengage slide tabs 32 from the slide slots 130, and locking tab 132 from anti-rotation slot 36.

At step 504, the second clamping member 104, is engaged to the first clamping member 102. Specifically, the second clamping member 104 is positioned proximate to the first clamping member 102 and rotated such that the projecting portion 142 of the second clamping member 104 engage with the cut-out portion 138 of the first clamping member 102. The engaging of the second clamping member 104 with the first clamping member 102 positions the first arm 110 adjacent to the second arm 116, whereby the openings 106 is defined around the elongated members 20 by the first arm 110 and the second arm 116. Due to such engagement of the first clamping member 102 and the second clamping member 104, the aperture 30 is sealed. Therefore, any likelihood of pressure drop, leakage, seepage and other such problems through the aperture 30 is avoided.

At step 506, the tightening member 120 is inserted through each of the first hole 136 and the second hole 144. Upon insertion, the free end portion 122 of the tightening member 120 may engage with the nut 124.

At step 508, the tightening member 120 is turned for locking the second clamping member 104 with respect to the first clamping member 102. The tightening member 120 may alternatively be turned in an opposite direction for unlocking the second clamping member 104 with respect to the first clamping member 102. The tightening member 120 may be conveniently turned by application of torque, for example using any conventional turning device, such as a wrench.

In an embodiment of the present disclosure, both the first clamping member 102 and the second clamping member 104 may engage to the aperture 30 from one side of the wall 10. Further, the tightening member 120 may be inserted from the same side of the wall 10. Therefore, the method 500 of permitting passage of the elongated members 20 through the wall 10 may be carried out from one side of the wall 10. Accordingly, the need of having access to both the sides of the wall 10 is avoided.

Aspects of this disclosure may also be applied to various household and industrial applications. Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims.

What is claimed is:

1. A clamping assembly for permitting passage of an elongated member through a wall, the clamping assembly comprising:
a first clamping member including a first arm extending outwardly from a first central portion of the first clamping member; and
a second clamping member including a second arm extending outwardly from a second central portion of the second clamping member, the second clamping member being configured to be removably engaged with the first clamping member, wherein the first arm and the second arm define an opening for permitting passage of the elongated member.

2. The clamping assembly of claim 1, wherein the first clamping member includes a first hole at the first central portion and the second clamping member includes a second hole at the second central portion.

3. The clamping assembly of claim 2 further including a tightening member capable of being removably inserted through each of the first hole and the second hole for locking the second clamping member with respect to the first clamping member.

4. The clamping assembly of claim 1, wherein the first arm includes a grooved portion and the second arm includes a complimentary grooved portion.

5. The clamping assembly of claim 1, wherein the first clamping member includes a mounting portion and a mating portion.

6. The clamping assembly of claim 5, wherein the mounting portion of the first clamping member includes slide slots.

7. The clamping assembly of claim 6, wherein the slide slots of the mounting portion of the first clamping member are configured to slidably receive slide tabs on an aperture on the wall.

8. The clamping assembly of claim 5, wherein the mounting portion of the first clamping member includes a locking tab.

9. The clamping assembly of claim 8, wherein the locking tab is configured to be engaged with an anti-rotation slot on the wall.

10. The clamping assembly of claim 1, wherein the first clamping member includes a cut-out portion and the second clamping member includes a projecting portion.

11. A clamping assembly for sealing an aperture on a wall, the clamping assembly comprising:
a first clamping member configured to be removably engaged with the aperture on the wall, the first clamping member including a first hole;
a second clamping member configured to be removably engaged with the first clamping member, the second clamping member including a second hole; and,
a tightening member capable of being removably inserted through each of the first hole and the second hole for selectively locking the second clamping member with respect to the first clamping member.

12. The clamping assembly of claim 11, wherein the first clamping member includes a mounting portion and a mating portion.

13. The clamping assembly of claim 12, wherein the mounting portion of the first clamping member includes slide slots.

14. The clamping assembly of claim 13, wherein the slide slots of the mounting portion of the first clamping member are configured to slidably receive slide tabs on the aperture on the wall.

15. The clamping assembly of claim 12, wherein the mounting portion of the first clamping member includes a locking tab.

16. The clamping assembly of claim 15, wherein the locking tab is configured to be engaged with an anti-rotation slot on the wall.

17. A method of permitting passage of an elongated member through a wall, the method comprising:
receiving the elongated member through an aperture on the wall;
engaging a first clamping member to the aperture;
engaging a second clamping member to the first clamping member;
inserting a tightening member through each of a first hole of the first clamping member and a second hole of the second clamping member; and,
turning the tightening member for locking the second clamping member with respect to the first clamping member.

18. The method of claim 17, wherein engaging the first clamping member to the aperture includes
receiving slide tabs on the aperture on the wall within slide slots of the first clamping member.

19. The method of claim 17, wherein engaging the first clamping member to the aperture further includes
engaging a locking tab of the first clamping member with an anti-rotation slot on the aperture on the wall.

20. The method of claim 17, wherein the engaging of the second clamping member with the first clamping member positions a first arm adjacent to a second arm, whereby an opening is defined by the first arm and the second arm.
